(19) United States
(12) Patent Application Publication
(10) Pub. No.: US 2010/0327824 A1
(43) Pub. Date: Dec. 30, 2010

(54) POWER SUPPLY USING SHARED FLUX IN A MULTI-LOAD PARALLEL MAGNETIC CIRCUIT

(76) Inventor: Richard Dellacona, Corona Del Mar, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/495,533

(22) Filed: Jun. 30, 2009

(51) Int. Cl. G05F 1/335

(52) U.S. Cl. 323/253

(57) ABSTRACT

A flux sharing magnetic circuit has a parallel arrangement of secondary flux loops with secondary windings to drive output loads. A shared pool of flux is provided by a primary winding. An AC driven primary delivers current to the secondary circuits to maintain a desired voltage or current to a load. One or more control windings control current in the parallel flux loops and thus control the power delivered to the loads.

### BACKGROUND

1. Field of the Invention

This disclosure relates generally to computer power supplies using multiple flux circuits in a magnetic regulator to increase efficiency.

2. Description of Related Art

Historically, computer power supplies were linear supplies that used a large linear (non-regulating) transformer to transform 115-volt AC line voltage down to the voltages needed by the computer circuits. The output current of the linear transformer was converted to DC and the DC power was provided to a linear regulator circuit to provide regulated voltage DC to the computer circuits. The linear transformers used in these power supplies were necessarily large and heavy. The linear regulators were also inefficient and wasted considerable power. Dissipating this wasted power required large heat sinks which further increased the size, weight, and cost of the supplies.

The undesirable qualities of the above linear power supplies led to the adoption of the switch-mode power supplies currently used in virtually all computer systems. In a switch-mode supply, the input 115 volt AC power is immediately converted to DC and then switched at a relatively high frequency (e.g., 50 kHz-1 MHz) using a solid-state switch to produce high-frequency AC. The high-frequency AC is typically provided to a high-frequency linear transformer that provides DC isolation, power conversion, and energy storage. The output of the transformer is rectified and filtered to produce the desired filtered DC output voltages. A feedback loop is provided from the filtered DC output to regulate the DC output by controlling the frequency and/or duty-cycle of the solid-state switch. Switch-mode power supplies are much smaller, lighter, and more efficient than linear power supplies. However, they are not without problems. The high frequency switching produces RF noise that can cause errors in digital circuits and noise in audio circuits. The solid-state switches cannot switch from on to off fast enough, and thus considerable power is wasted in the solid-state switch. Further, the power factor of switch-mode supplies tends to be poor because of the current spikes produced by the high-speed switching.

### SUMMARY

These and other problems are solved by a magnetically-regulated power supply wherein a plurality of output secondary circuits are provided to parallel magnetic flux paths. Each one of the secondary circuits has a secondary coil, and each secondary coil is provided with one or more control coils. In one embodiment, the control coils are coaxially wound, linearly aligned and in an electrical series connection, with two control coils, with the control coils wound in opposite sense to each other. The secondary coils may be wound for different output voltages as required by their respective loads. The series coils, in each of the secondary circuits, are provided to a voltage regulator. In one embodiment, the voltage regulator comprises a battery. In one embodiment, the output from a secondary coil is converted to DC such that DC is provided to the regulator. In one embodiment, the regulator includes an energy storage element such as, for example, a battery, a capacitor, and inductor, etc. and/or combinations thereof.

In one embodiment, the primary coil and the series coils in each of the secondary circuits are arranged in magnetically parallel branches and therefore are able to share magnetic flux developed across the parallel magnetic circuit arrangement.

In one embodiment, a flux-sharing inductive circuit provides power to multiple loads while using less input power at the primary. In one embodiment, the flux-sharing inductive circuit includes parallel flux circuits. In one embodiment, one or more control coils are provided to one or more of the parallel flux circuits.

In one embodiment, a primary winding is provided to a first portion of a core of magnetic material having a non-linear hysteresis, the primary core energized by an AC voltage. A first secondary circuit includes a first secondary winding, first control winding and a first control circuit. The first secondary winding and the first control winding are provided to the first control circuit, the first control circuit controlling a current through the first control winding to at least partially regulate an output voltage of the first control circuit. The first secondary winding and the first control winding are provided to a second portion of the core of magnetic material to form a first magnetic flux loop including the first portion and the second portion. A second secondary circuit includes a second secondary winding, second control winding and a second control circuit. The second secondary winding and the second control winding are provided to the second control circuit, the second control circuit controlling a current through the second control winding to regulate a desired output voltage of the second control circuit. The second secondary winding and the second control winding are provided to a third portion of the core of magnetic material to form a second magnetic flux loop including the first portion and the third portion, the second flux loop in parallel with the first magnetic flux loop such that a magnetic flux through the primary winding includes a combination of magnetic flux from the first magnetic flux loop and magnetic flux from the second magnetic flux loop.

In one embodiment, the first secondary winding is provided in series with the first control winding. In one embodiment, the first secondary winding is wound in an opposite sense with respect to the first control winding. In one embodiment, the first secondary winding is provided in series with the first control winding and the first secondary winding is wound such that the first secondary winding is out of phase with respect to the first control winding.

In one embodiment, the first control circuit includes a load control circuit and a first control winding control circuit. In one embodiment, the first control circuit includes diode to convert alternating current from the first secondary winding to direct current and a filter to smooth the direct current. In one embodiment, the filter includes a lowpass filter. In one embodiment, the filter provides voltage regulation. In one embodiment, the filter includes an electrochemical cell. In one embodiment, the filter includes a rechargeable battery.

In one embodiment, the first winding control circuit includes a resistor provided shut with the first control winding. In one embodiment, the first winding control circuit includes an electronically-variable resistance provided shut with the first control winding and where a resistance of the electronically-variable resistance is controlled at least in part by the load control circuit. In one embodiment, the first winding control circuit is controlled at least in part by the load control circuit. In one embodiment, a current through the first control winding creates a flux in the first member and the flux causes a non-linearity of the non-linear hysteresis to regulate an output voltage of the first secondary winding.

One embodiment includes providing an alternating current to a primary winding to induce a magnetic flux in a first member of a core of magnetic material having a non-linear hysteresis curve, inducing a voltage in a first secondary winding provided to a second member of the core of magnetic material, wherein the first member and the second member form a first flux loop inducing a voltage in a first control winding provided to the second member, controlling a current in the first control winding to produce a desired first output voltage across a series combination of the first secondary winding and the first control winding, inducing a voltage in a second secondary winding provided to a third member of the core of magnetic material, wherein the first member and the second member form a second flux loop in parallel with the first flux loop such that the flux through the first member is common to flux through the first flux loop and the second flux loop, inducing a voltage in a second control winding provided to the third member, and controlling a current in the first control winding to produce a desired second output voltage across a series combination of the first secondary winding and the first control winding.

One embodiment further includes inducing a voltage in a third control winding provided to the second member, the third control winding in series with the first secondary winding and the first control winding.

In one embodiment, the first secondary winding is wound in an opposite sense with respect to the first control winding.

In one embodiment, the first secondary winding is wound such that voltage induced in the first secondary winding is out of phase with respect to voltage induced in the first control winding.

One embodiment further includes converting the first desired output voltage to DC voltage. One embodiment further includes filtering the DC voltage. One embodiment further includes regulating the DC voltage. One embodiment further includes using an electrochemical cell to filter the DC voltage. One embodiment further includes using a rechargeable battery to filter the DC voltage. One embodiment further includes regulating the first desired voltage by shunting current around the first control winding. One embodiment further includes regulating the first desired voltage by using a resistor to shunt current around the first control winding. One embodiment further includes varying a resistance of the shunt resistor.

### BRIEF DESCRIPTION OF THE DRAWINGS

FIG. 1 shows a magnetically-regulated power supply having two secondary windings, a pair of control windings for each secondary, and a control circuit for each secondary.

FIG. 2 shows the magnetically-regulated power supply of FIG. 1 wherein the control circuits include a load control circuit and one or more control winding control circuits.

FIG. 3 shows the magnetically-regulated power supply of FIG. 2 wherein the control winding control circuits include resistor control.

FIG. 4 shows the magnetically-regulated power supply of FIG. 2 wherein the control winding control circuits are controlled by respective load control circuits.

FIG. 5 shows the magnetically-regulated power supply of FIG. 2 wherein the control winding control circuits include variable resistances controlled by the by respective load control circuits.

FIG. 6 shows the magnetically-regulated power supply of FIG. 3 wherein the load control circuits use one or more electrochemical cells to provide voltage regulation.

FIG. 7 shows the magnetically-regulated power supply of FIG. 6 wherein the floating loads are provided to a common ground.

FIG. 8 shows one embodiment of a power transformer having two parallel flux loops.

FIG. 9 shows one embodiment of a magnetic power supply having three parallel flux loops.

FIG. 10 shows one embodiment of a power transformer having three parallel flux loops.

### DETAILED DESCRIPTION

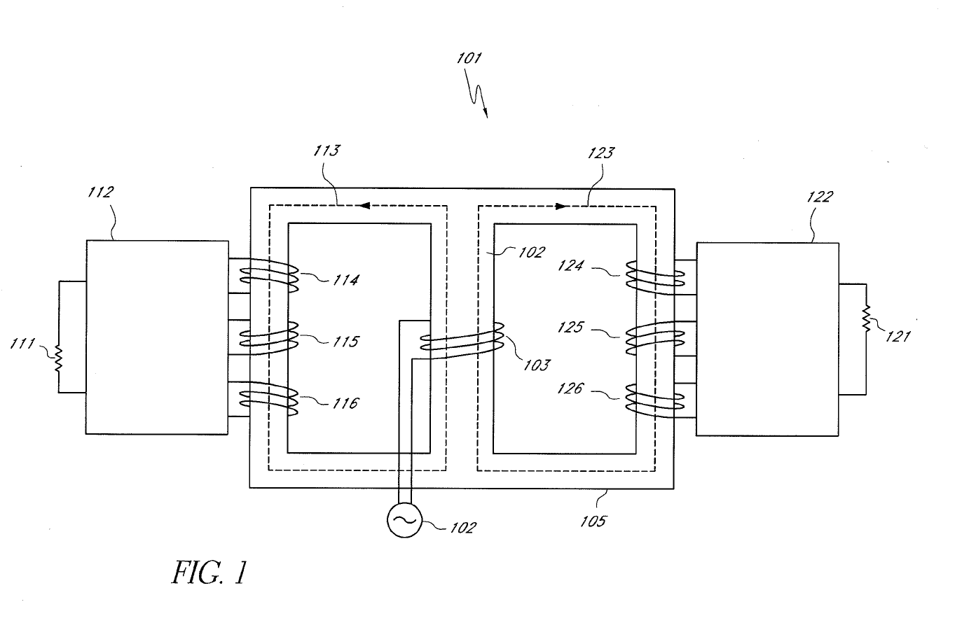

FIG. 1 shows a magnetically-regulated power supply 101 having a magnetic core 105 and a primary winding 103. The magnetic core is composed of magnetic material with such as, for example, iron, ferrite, cobalt, nickel, combinations thereof, etc. The magnetic core 105 has two parallel flux loops 113 and 123 respectively. The two flux loops 113 and 123 share a common branch upon which the primary winding 103 is provided. A first secondary winding 115 and corresponding first control windings 114 and 116 are provided to a secondary branch of the first flux loop 113 (where that secondary branch is not shared by the second flux loop 123). A second secondary winding 125 and corresponding second control windings 124 and 126 are provided to a secondary branch of the second flux loop 123 (where that secondary branch is not shared by the first flux loop 113). A first control circuit 112 is provided to the windings 114-116 and to a first load 111. A second control circuit 122 is provided to the windings 124-126 and to a second load 121. An AC input power source 102 is provided to the primary winding 103. In one embodiment, the control windings 114 and 116 are wound in the opposite sense as compared to the secondary winding 115 such that current in the control windings 114 and 116 produces magnetic flux to oppose the magnetic flux produced by the secondary winding 115. The magnetic material of the core is configured with a desired hysteresis curve to such that the core 105 and windings 103, 114-116 and 124-126 operate as a magnetic amplifier-type magnetic circuit to provide voltage regulation of voltage and/or current by using, at least in part, nonlinearity of the hysteresis curve.

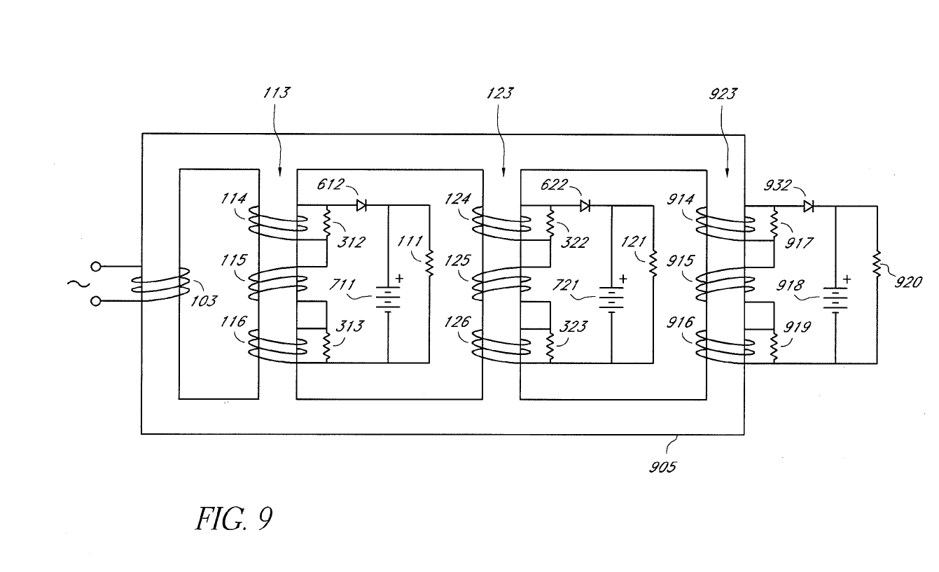

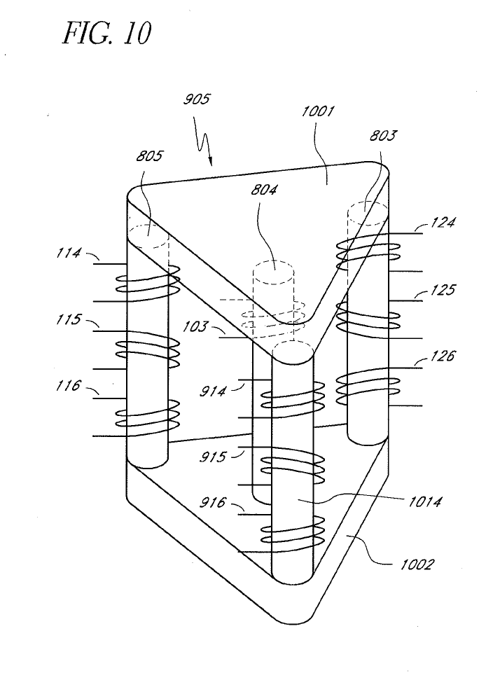

The illustration of two loops paths is used in FIG. 1 for purposes of illustration and is not intended to be limiting. One of ordinary skill in the art will recognize that more than two parallel flux loops can be provided. Thus, for example, three, four, five, or more flux loops can be provided (see e.g., FIGS. 9 and 10 below where an example of three parallel flux loops is shown). Typically, each parallel flux loop links the primary winding 103 and each parallel flux loop is provided with one or more secondary windings and one or more control windings. However, one of ordinary skill in the art will recognize that other variations can be used. For example, in some embodiments, it is not necessary for each flux loops to be provided with control windings. Thus, in one embodiment, one or more of the parallel flux loops are provided with one or more control windings and in one or more of the parallel flux loops the secondary windings are omitted. One of ordinary skill in the art will also recognize that although two control windings per flux loop are shown, it is not required to have exactly two control windings and the apparatus can be provided with one or more control windings for each flux loop. Moreover, it is not necessary to have the same number of control windings for each flux loop and thus the number of control windings per parallel flux loop can be different for the different flux loops.

The first control circuit 112 receives power from the secondary winding 115 and provides power to the control windings 114 and 116 to regulate the voltage (and/or current) provided to the load 111. In one embodiment, the control circuit 112 provides direct current (DC) to the load 111. In one embodiment, the control circuit 112 provides alternating current (AC) to the load 111. The second control circuit 122 receives power from the secondary winding 125 and provides power to the control windings 124 and 126 to regulate the voltage (and/or current) provided to the load 121. In one embodiment, the control circuit 122 provides direct current (DC) to the load 121. In one embodiment, the control circuit 122 provides alternating current (AC) to the load 121. In one embodiment, the control circuit 112 regulates the power provided to the load 111. In one embodiment, the control circuit 122 regulates the power provided to the load 121.

In one embodiment, the core 105 and windings 114-116 and 124-126 operate as a magnetic amplifier wherein one or more portions of the core 105 are operated in a non-linear fashion. In one embodiment, the ratio of magnetic flux to electric flux in the portion of the core 105 passing through the secondary winding 115 is controlled by the current in the control windings 114 and 116 to produce a desired voltage across the load 111 and the ratio of magnetic flux to electric flux in the portion of the core 105 passing through the secondary winding 125 is controlled by the current in the control windings 124 and 126 to produce a desired voltage across the load 121.

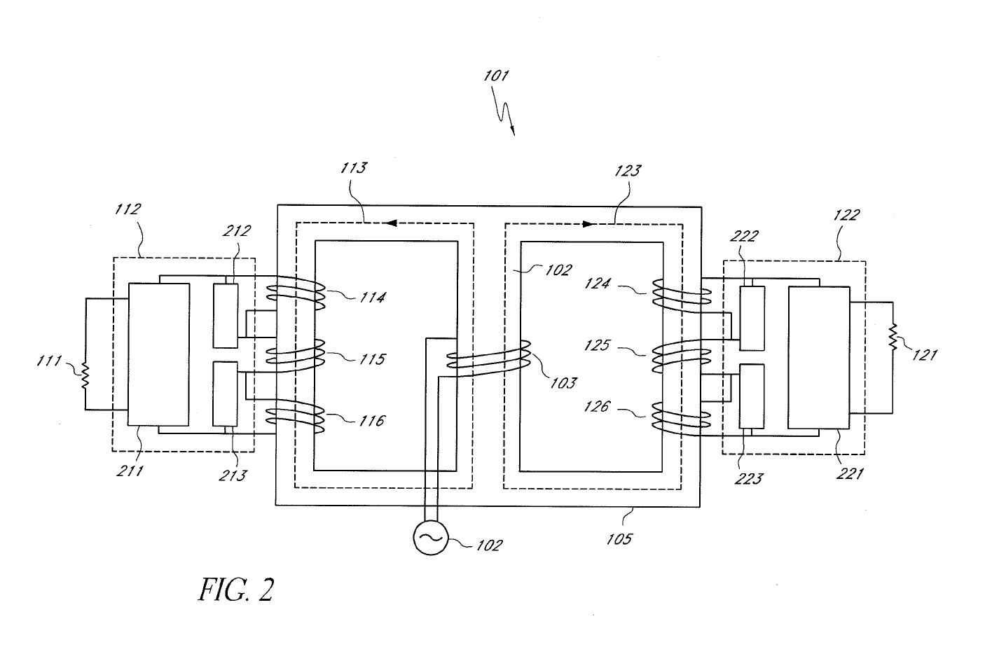

FIG. 2 shows the magnetically-regulated power supply of FIG. 1 wherein the control circuits 112, 122 include respective load control circuits and one or more respective control winding control circuits. In FIG. 2, the magnetically-regulated power supply 101 includes the magnetic core 105 and the primary winding 103. The magnetic core 105 has two parallel flux loops 113 and 123 respectively. The two flux loops 113 and 123 share a common branch upon which the primary winding 103 is provided. The first secondary winding 115 and corresponding first control windings 114 and 116 are provided to the secondary branch of the first flux loop 113 (where that secondary branch is not shared by the second flux loop 123). The second secondary winding 125 and corresponding second control windings 124 and 126 are provided to the secondary branch of the second flux loop 123 (where that secondary branch is not shared by the first flux loop 113). The first control circuit 112 is provided to the windings 114-116 and to a first load 111. A second control circuit 122 is provided to the windings 124-126 and to a second load 121.

The control circuit 112 includes a load control circuit 211 and winding control circuits 212 and 213. A first terminal of the control winding 114 is provided to a first terminal of the load control circuit 211 and to a first terminal of the winding control circuit 212. A second terminal of the control winding 114 is provided to a second terminal of the winding control circuit 212 and to a first terminal of the secondary winding 115. A first terminal of the control winding 116 is provided to a first terminal of the load control circuit 211 and to a first terminal of the winding control circuit 213. A second terminal of the control winding 116 is provided to a second terminal of the winding control circuit 213 and to a second terminal of the secondary winding 115.

The control circuit 122 includes a load control circuit 221 and winding control circuits 222 and 223. A first terminal of the control winding 124 is provided to a first terminal of the load control circuit 221 and to a first terminal of the winding control circuit 222. A second terminal of the control winding 124 is provided to a second terminal of the winding control circuit 222 and to a first terminal of the secondary winding 125. A first terminal of the control winding 126 is provided to a first terminal of the load control circuit 221 and to a first terminal of the winding control circuit 223. A second terminal of the control winding 126 is provided to a second terminal of the winding control circuit 223 and to a second terminal of the secondary winding 125.

In one embodiment, the winding control circuit 212 shunts current around the control winding 114 to control the amount of current in the control winding 114 and thus the magnetic flux produced by the control winding 114. Since the control winding 114 is in the same flux loop as the secondary winding 115, changing the amount of magnetic flux produced by the control coil 114 changes the magnetic flux through the secondary winding 115 and thus controls the output voltage of the secondary winding 115. The winding control circuit 213 controls the current through the control windings 116 to also control the flux through the secondary winding 115. Similarly, the winding control circuits 222 and 223 control the current through respective control windings 124 and 126 to control the flux through the secondary winding 125. Since the control windings 114, 116 and 124, 126 are wound in a winding sense opposite their respective secondary windings 115 and 125, shunting current around the control windings increases the voltage provided to the load control circuit from the series combination of the secondary windings and associated control windings. Thus, for example, in FIG. 2 the windings 114-116 are in series and the total series voltage is provided to the load control circuit 211. However, the voltage produced by the control windings 114, 116 is 180 deg. out of phase with respect to the voltage produced by the secondary winding 115 and thus, in the absence of the resistors 312, 313 the voltage across the control windings 116, 116 reduces the total voltage across the series combination of the windings 114-116. The resistors 312 and 313 shunt current from the secondary winding 115 around the control windings 114, 115 to regulate the voltage provided to the load control circuit 211. At the same time the resistors 312 and 313 load the respective control windings 114 and 116 and the current in the control windings 114 and 116 cooperates with the nonlinearity of the core 105 to provide feedback to control the output voltage provided to the load control circuit 211.

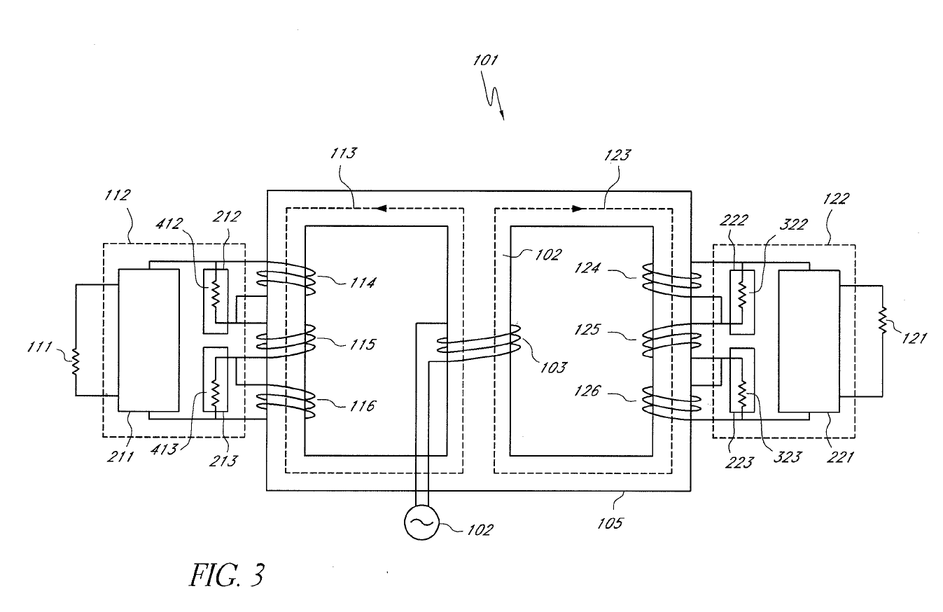

FIG. 3 shows the magnetically-regulated power supply of FIG. 2 wherein the control winding control circuits 212, 213, 222, and 223 are substantially passive circuits. In FIG. 2, the first terminal of the winding control circuit 212 is provided to a first terminal of a resistor 312 and the second terminal of the winding control circuit 212 is provided to a second terminal of the resistor 312. The first terminal of the winding control circuit 213 is provided to a first terminal of a resistor 313 and the second terminal of the winding control circuit 213 is provided to a second terminal of the resistor 313. The first terminal of the winding control circuit 222 is provided to a first terminal of a resistor 322 and the second terminal of the winding control circuit 222 is provided to a second terminal of the resistor 322. The first terminal of the winding control circuit 213 is provided to a first terminal of a resistor 323 and the second terminal of the winding control circuit 223 is provided to a second terminal of the resistor 323.

The resistor 312 shunts current around the control winding 114 to control the amount of current in the control winding 114 and thus the magnetic flux produced by the control winding 114. The resistor 313 shunts current around the control winding 116 to further control the flux through the secondary winding 115. Similarly, the resistors 322 and 323 shunt current around respective control windings 124 and 126 to control the flux through the secondary winding 125.

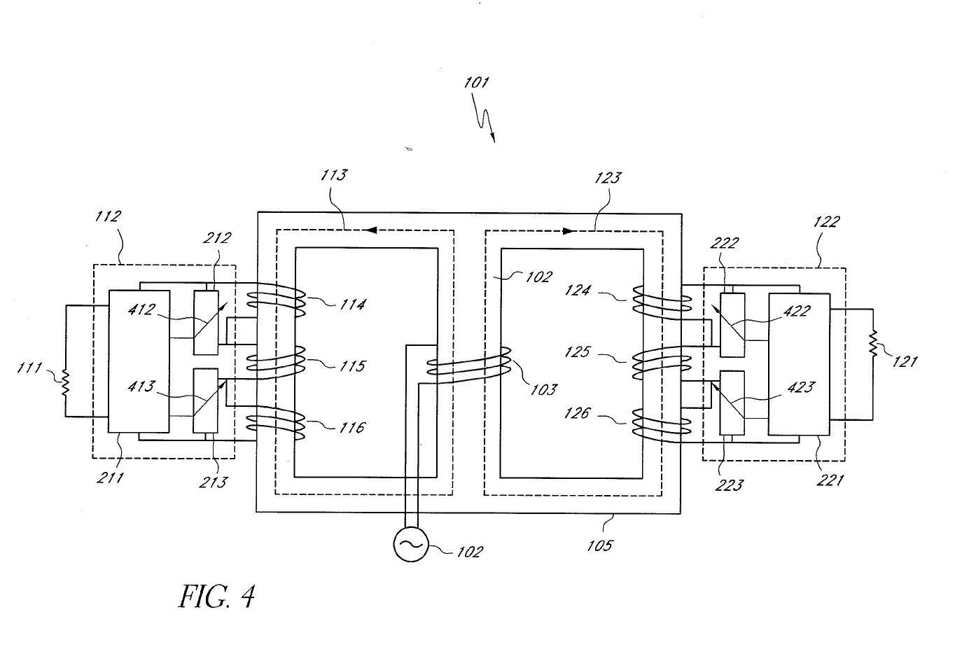

FIG. 4 shows the magnetically-regulated power supply of FIG. 2 wherein the control winding control circuits 212, 213, 222 and 223 are controlled by respective load control circuits 211 and 221 to control the power provided to the loads 111 and 121. In FIG. 4, a control output 412 from the load control circuit 211 is provided to a control input of the winding control circuit 212, a control output 413 from the load control circuit 211 is provided to a control input of the winding control circuit 213, a control output 422 from the load control circuit 221 is provided to a control input of the winding control circuit 212, and a control output 423 from the load control circuit 221 is provided to a control input of the winding control circuit 223.

The control outputs 412, 413, 422, and 423 control respective winding control circuits 212, 213, 222, and 223 to cause the winding control circuits 212, 213, 222, and 223 to provide the desired voltage regulation. In one embodiment, the control output 412 controls the winding control circuit 212 to cause the winding control circuit to present the desired impedance (real and/or complex impedance) to the control winding 114 to regulate the voltage provided to the load control circuit 112. In one embodiment, the control output 412 controls the winding control circuit 212 to cause the winding control circuit 212 to shunt a desired amount of current around the control winding 114 to regulate the voltage provided to the load control circuit 112. In one embodiment, the control output 412 controls the winding control circuit 212 to cause the winding control circuit 212 to produce a desired amount of current in the control winding 114 to regulate the voltage provided to the load control circuit 112.

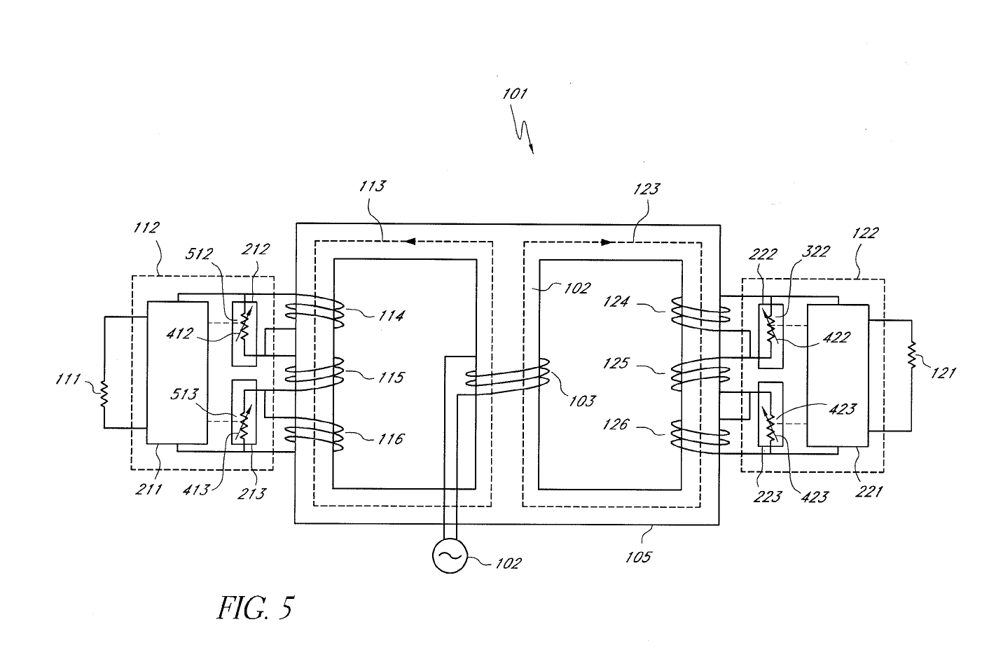

FIG. 5 shows the magnetically-regulated power supply of FIG. 4 wherein the control winding control circuits include variable resistances controlled by the by respective load control circuits. In FIG. 5, the control output 412 controls a variable resistor 512 in the control winding circuit 212, the control output 413 controls a variable resistor 513 in the control winding circuit 213, the control output 422 controls a variable resistor 522 in the control winding circuit 222, and the control output 423 controls a variable resistor 523 in the control winding circuit 223.

In one embodiment, the variable resistors 512, 513, 522, and 523 perform a similar function to the resistors 312, 313, 322, and 323 shown in FIG. 3 with the added benefit that the load control circuits 112 and 122 and control the resistance of the resistors 512, 513, 522, and 523 to produce the desired voltage, current, and/or power regulation. In one embodiment, the variable resistors 512, 513, 522, and 523 are configured using solid state devices such as, for example, transistors, FETS, MOSFETS, etc.

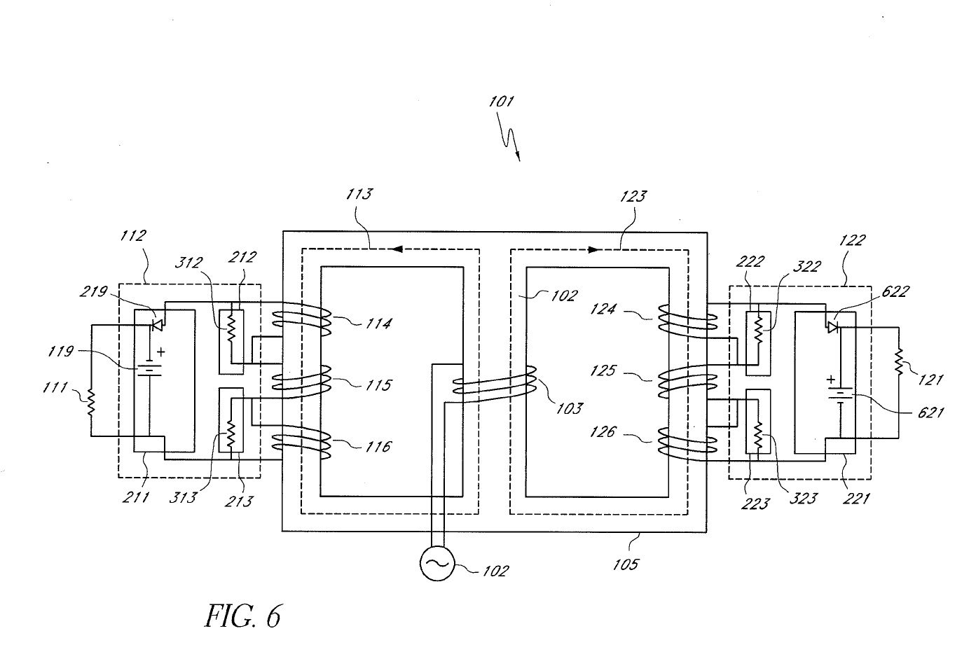

FIG. 6 shows the magnetically-regulated power supply of FIG. 3 wherein the load control circuits use one or more electrochemical cells to provide voltage regulation. In FIG. 3, the load control circuit 211 includes a diode 612 and an electrochemical cell 611. The first terminal of the control winding 114 is provided to an anode of the diode 612. A cathode of the diode 612 is provided to a positive terminal of the cell 611 and to a first terminal of the load 111. The first terminal of the control winding 116 is provided to a negative terminal of the cell 611 and to a second terminal of the load 111. The load control circuit 212 includes a diode 622 and an electrochemical cell 621. The first terminal of the control winding 124 is provided to an anode of the diode 622. A cathode of the diode 622 is provided to a positive terminal of the cell 621 and to a first terminal of the load 112. The first terminal of the control winding 126 is provided to a negative terminal of the cell 621 and to a second terminal of the load 112. In one embodiment, the cells 611 and 621 include electrochemical cells such as, for example, rechargeable batteries (e.g., lithium ion batteries, nickel-metal hydride batteries, nickel-cadmium batteries etc.). The cells 611 and 621 provide voltage regulation and filtering. Thus, for example, the cell 611 can store energy when the diode 612 is forward biased and providing current, and the call 611 can provide energy when the diode 612 is reversed biased. Moreover, since a charged electrochemical cell operates a nominal cell voltage determined by the chemistry of the cell, the cell 611 provides voltage regulation. One of ordinary skill in the art will recognize that the cells 611 and 612 are described herein as electrochemical cells for purposes of illustration, and the cells 611 and 612 can be replaced (in whole or in part) with electronic circuits that provide voltage regulation and filtering of the rectified AC voltage.

When the cell 611 is relatively charged, the current through the resistors 312 and 313 increases thereby increasing the flux through respective control windings 114 and 116. Since the flux in the control windings 114 and 116 opposes the flux flowing through the secondary coil 115, the output voltage of the coil 115 is reduced thus reducing current flow to the cell 611. When this happens, the magnetic field at the secondary winding 115 collapses, or at least partially collapses, producing a reverse current which generates a flux which is additive to the flux in the primary winding 103. This limits current flow in the primary winding 103 and thus reduces the current drawn from the source 102.

The power in the flux through the secondary windings is converted to electrical power delivered to the loads 111, 121. Since the flux through the primary winding 103 is common to both the flux loop 113 through the first secondary coil 115 and the flux loop 123 through the second secondary winding 125, the flux through the primary winding 103 acts as a common pool of flux that can be shared between or provided to the secondary windings.

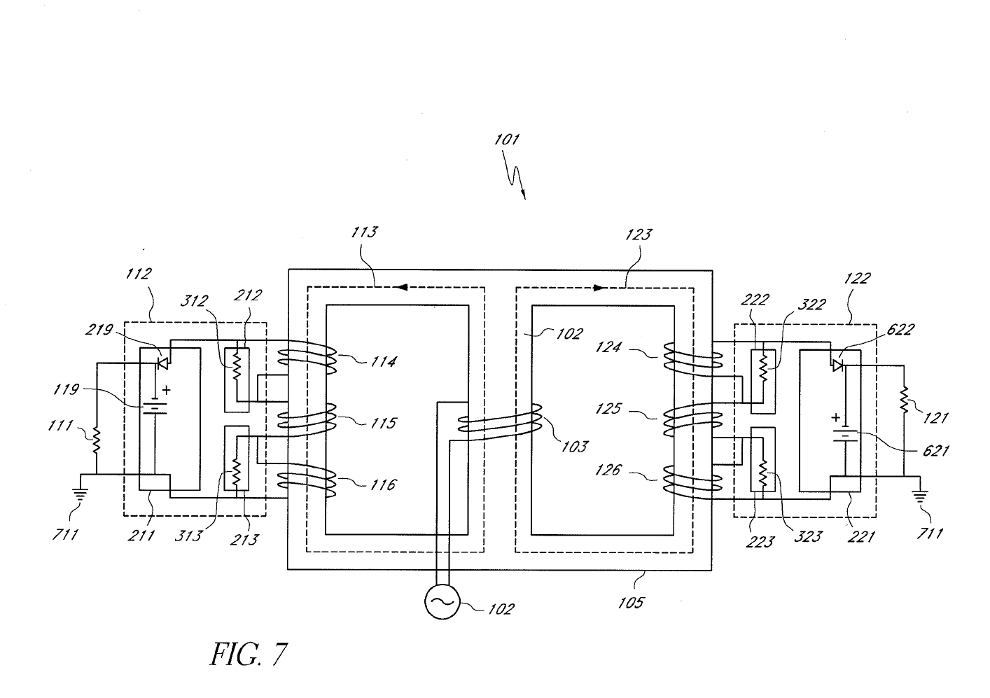

FIG. 7 shows the magnetically-regulated power supply of FIG. 6 wherein the floating loads are provided to a common ground 711.

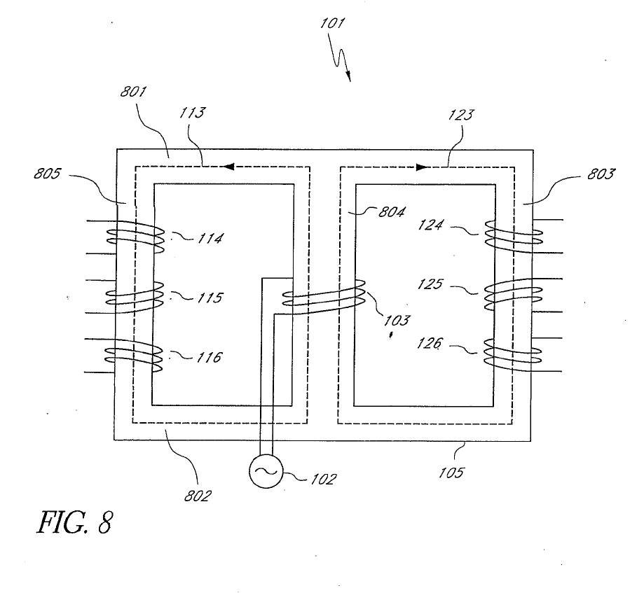

FIG. 8 shows one embodiment of a power transformer having the two parallel flux loops 113 and 123. In FIG. 8, the core 105 includes a first end member 801 and a second end member 802. A first core member 804 is provided between the end members 801 and 802 and a second core member 805 is provided between the end members 801 and 802 such that the first flux loop 113 circulates through a magnetic circuit formed by the first end member 801, the first core member 804, the second end member 802 and the second core member 805. A third core member 803 is provided between the end members 801 and 802 such that the second flux loop 123 circulates through a magnetic circuit formed by the first end member 801, the first core member 804, the second end member 802 and the third core member 803. The primary winding 103 is provided to the first core member 804. The windings 114, 115, and 116 are provided to the second core member 805. The windings 124, 125, and 126 are provided to the third core member 804.

FIG. 9 shows the magnetically-regulated power supply of FIG. 7 with the addition of a third flux loop and a third load 920. In FIG. 9, the core 105 having two flux loops is replaced with a core 905 having three flux loops. FIG. 9 shows the core 905 in a schematic form where the parallelism of the three flux loops is represented schematically. FIG. 10 shows a more complete description of the parallel flux loops of the core 905. FIG. 9 includes the windings 114-116 and their associated circuits and load 111 and the windings 124-126 and their associated circuits and load 121. In addition, the third flux loop of the core 905 is provided to a control winding 914, a secondary winding 915 and a control winding 916. As with the windings 114-116, the windings 914-916 are in series. A resistor 917 is provided in parallel with the control winding 914 and a resistor 919 is provided in parallel with the control winding 919. A first terminal of the series of windings 914-916 is provided through a diode 932 to a positive terminal of a cell 918. A second terminal of the series of windings 914-916 is provided to a negative terminal of the cell 918. First and second terminals of the load 920 are provided to the respective positive and negative terminals of the cell 918.

FIG. 10 shows one embodiment of a power transformer having a core 905 with three parallel flux loops. In FIG. 10, the core 905 includes a first end member 1001 and a second end member 1002. The first core member 804 is provided between the end members 1001 and 1002 and the second core member 805 is provided between the end members 1001 and 1002 such that the first flux loop 113 circulates through a magnetic circuit formed by the first end member 1001, the first core member 804, the second end member 1002 and the second core member 805. A third core member 803 is provided between the end members 1001 and 1002 such that the second flux loop 123 circulates through a magnetic circuit formed by the first end member 1001, the first core member 804, the second end member 1002 and the third core member 803. A fourth core member 1014 is provided between the end members 1001 and 1002 such that the third flux loop 923 circulates through a magnetic circuit formed by the first end member 1001, the first core member 804, the second end member 1002 and the third core member 1014.

The primary winding 103 is provided to the first core member 804. The windings 114, 115, and 116 are provided to the second core member 805. The windings 124, 125, and 126 are provided to the third core member 804. The windings 914-916 are provided to the fourth core member 1014.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for anyone of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas. Thus, the invention is limited only the claims that follow (and equivalents).

What is claimed is:

1. A power supply comprising:
a primary winding provided to a first portion of a core of magnetic material having a non-linear hysteresis, the primary core energized by an AC voltage;
a first secondary circuit, said secondary circuit comprising a first secondary winding, at least one first control winding and a first control circuit, said first secondary winding and said first at least one control winding provided to said first control circuit, said first control circuit controlling a current through said at least one first control winding to at least partially regulate an output voltage of said first control circuit, said first secondary winding and said at least one first control winding provided to a second portion of said core of magnetic material to form a first magnetic flux loop comprising said first portion and said second portion; and
a second secondary circuit, said second secondary circuit comprising a second secondary winding, at least one second control winding and a second control circuit, said second secondary winding and said second at least one control winding provided to said second control circuit, said second control circuit controlling a current through said at least one second control winding to regulate a desired output voltage of said second control circuit, said second secondary winding and said at least one second control winding provided to a third portion of said core of magnetic material to form a second magnetic flux loop comprising said first portion and said third portion, said second flux loop in parallel with said first magnetic flux loop such that a magnetic flux through said primary winding comprises a combination of magnetic flux from said first magnetic flux loop and magnetic flux from said second magnetic flux loop.

2. The power supply of claim 1, wherein said first secondary winding is provided in series with said first at least one first control winding.

3. The power supply of claim 1, wherein said first secondary winding is wound in an opposite sense with respect to said first at least one control winding.

4. The power supply of claim 1, wherein said first secondary winding is provided in series with said first at least one control winding and said first secondary winding is wound such that said first secondary winding is out of phase with respect to said first at least control winding.

5. The power supply of claim 1, wherein said first control circuit comprises a load control circuit and a first control winding control circuit.

6. The power supply of claim 5, wherein said first control circuit comprises a diode to convert alternating current from said first secondary winding to direct current and a filter to smooth said direct current.

7. The power supply of claim 6, wherein said filter comprises a lowpass filter.

8. The power supply of claim 6, wherein said filter provides voltage regulation.

9. The power supply of claim 6, wherein said filter comprises an electrochemical cell.

10. The power supply of claim 6, wherein said filter comprises a rechargeable battery.

11. The power supply of claim 5, wherein said first winding control circuit comprises a resistor provided shut with said first at least one control winding.

12. The power supply of claim 5, wherein said first winding control circuit comprises an electronically-variable resistance provided shut with said first at least one control winding and where a resistance of said electronically-variable resistance is controlled at least in part by said load control circuit.

13. The power supply of claim 5, wherein said first winding control circuit is controlled at least in part by said load control circuit.

14. The power supply of claim 5, wherein a current through said first at least one control winding creates a flux in said first member and wherein said flux causes a non-linearity of said non-linear hysteresis to regulate an output voltage of said first secondary winding.

15. A method of voltage regulation, comprising:
providing an alternating current to a primary winding to induce a magnetic flux in a first member of a core of magnetic material having a non-linear hysteresis curve;
inducing a voltage in a first secondary winding provided to a second member of said core of magnetic material, wherein said first member and said second member form a first flux loop;
inducing a voltage in a first control winding provided to said second member;
controlling a current in said first control winding to produce a desired first output voltage across a series combination of said first secondary winding and said first control winding;
inducing a voltage in a second secondary winding provided to a third member of said core of magnetic material, wherein said first member and said second member form a second flux loop in parallel with said first flux loop such that said flux through said first member is common to flux through said first flux loop and said second flux loop;
inducing a voltage in a second control winding provided to said third member; and
controlling a current in said first control winding to produce a desired second output voltage across a series combination of said first secondary winding and said first control winding.

16. The method claim 15, further comprising inducing a voltage in a third control winding provided to said second member, said third control winding in series with said first secondary winding and said first control winding.

17. The method of claim 15, wherein said first secondary winding is wound in an opposite sense with respect to said first control winding.

18. The method of claim 15, wherein said first secondary winding is wound such that voltage induced in said first secondary winding is out of phase with respect to voltage induced in said first control winding.

19. The method of claim 15, further comprising converting said first desired output voltage to DC voltage.

20. The method of claim 19, further comprising filtering said DC voltage.

21. The method of claim 19, further comprising regulating said DC voltage.

22. The method of claim 19, further comprising using an electrochemical cell to filter said DC voltage.

23. The method of claim 19, further comprising using a rechargeable battery to filter said DC voltage.

24. The method of claim 19, further comprising regulating said first desired voltage by shunting current around said first control winding.

25. The method of claim 19, further comprising regulating said first desired voltage by using a resistor to shunt current around said first control winding.

26. The method of claim 25, further comprising varying a resistance of said resistor.

27. A power supply, comprising:
means for inducing flux in a common branch of a first flux loop and a parallel second flux loop;
means for inducing a voltage in a first secondary winding and a first control winding from magnetic flux in said first flux loop;
means for controlling a current in said first control winding to produce a desired first output voltage across a series combination of said first secondary winding and said first control winding;
means for inducing a voltage in a second secondary winding and a second control winding provide to said second flux loop; and
means for controlling a current in said first control winding to produce a desired second output voltage across a series combination of said first secondary winding and said first control winding.

28. The power supply of claim 27, further comprising means for converting said first desired output voltage to DC voltage.

29. The power supply of claim 28, further comprising means for filtering said DC voltage.

30. The power supply of claim 28, further comprising means for regulating said DC voltage.

31. The method of claim 27, further comprising means for shunting current around said first control winding.

32. The power supply of claim 27, further comprising means for varying a current shunted around said first control winding.
